(19) United States
(12) Patent Application Publication
(10) Pub. No.: US 2024/0028925 A1
(43) Pub. Date: Jan. 25, 2024

(54) AUTOMATED ACTION RECOMMENDER FOR STRUCTURED PROCESSES

(71) Applicant: Accenture Global Solutions Limited, Dublin 4 (IE)

(72) Inventors: Kamalesh Kuppusamy Kuduva, Bangalore (IN); Vaira Selvam Rajagopalan, Madurai (IN); Siddesha Swamy, Bangalore (IN); Rishikesh Shrinivas Sapar, Pune (IN)

(21) Appl. No.: 17/869,788

(22) Filed: Jul. 20, 2022

(51) Int. Cl. G06N 5/04; G06N 5/02

(52) U.S. Cl. CPC G06N 5/04; G06N 5/022

(57) ABSTRACT

Aspects of the present disclosure provide systems, methods, apparatus, and computer-readable storage media that support automated action recommendation for structured processes. Aspects described herein leverage trained machine learning (ML) models to assign features extracted from historical event data into multiple clusters using unsupervised learning. In some implementations, current event data of a structured process is received, and extracted features assigned to one of the multiple clusters by the ML models. Candidate event sequences are generated based on members of the assigned cluster and are filtered based on corresponding association rule scores. Multiple incremental candidate sub-sequences are generated from the remaining candidate event sequences, and these are filtered based on a current event level and corresponding association rule scores. The remaining candidate sub-sequences are ranked based on the scores, and at least one of the highest ranking candidate sub-sequences are provided as recommended event sequences.

### TECHNICAL FIELD

The present disclosure relates generally to automated action recommendation, and more particularly, to leveraging artificial intelligence and machine learning in combination with data mining to recommend sequences of actions to complete performance of structured processes.

### BACKGROUND

Many organizations, businesses, or other entities focus on the performance of structured processes. A structured process refers to a formally defined or standardized sequence of tasks that begins with a start event and ends in one or more end events. Performance of at least some of the tasks results in one or more defined outcomes (e.g., end events). Examples of structured processes include a loan approval process, an insurance claim handling process, a new user addition process, an account transfer process, a document generation process, a maintenance or repair process, a system configuration process, a system upgrade process, or the like. One of the benefits of structured processes is that the sequences of events (e.g., tasks) performed to complete a structured process is standardized across entities, employees, locations, situations, and the like. Although there could be conditional events in a structured process that can result in different sequences of tasks (e.g., actions) being performed for different instances of the structured process, the total combination actions that are performed is standardized, resulting in at least some predictability for the entity.

For many structured processes, performance typically follows a few event sequences, and the remainder of events defined for the structured process are rarely, if ever, performed. For example, for an insurance claim handling process, most claims are handled by one or two common event paths through a standardized handling process, with only a few claims requiring other paths to handle without breaching target parameters or agreements, such as client satisfaction rates. However, these few tasks can result in a large majority of the time and resources spend by employees of an entity or a large majority of technological resources in performing a structured task. Entities are under increasing pressure to streamline structured processes, such as by reducing the number of “pattern variants” (e.g., different paths through the flow of a structured process) in order to increase efficiency of resource use and reduce time spend completing instances of the structured process. However, the more complicated a structured process is, such as structured processes with multiple different branching paths to multiple different end events, the more difficult it is to streamline the structured processes, resulting in substantial technology resources and human resources being devoted to performance of structured processes.

### SUMMARY

Aspects of the present disclosure provide systems, methods, and computer-readable storage media that support automated action recommendation for structured processes. The aspects described herein leverage machine learning (ML) and artificial intelligence (AI) algorithms and/or models to assign features corresponding to previously performed event sequences into clusters based on underlying feature relationships using unsupervised learning. This clustering is then used to predict a cluster to which a current or new instance of a structured process is to be assigned. The event sequences that correspond to members of the assigned cluster are used to generate candidate event sequences using data mining, latticing, and other techniques. The data mining includes reducing the total number of candidate event sequences based on scores determined from application of associative rules and, after the reduction, generating multiple incrementally ordered candidate sub-sequences. The candidate sub-sequences can be pruned and filtered based on a current event level of the current or new instance, as well as based on corresponding associate rule scores, to generate an incremental ordering of candidate sub-sequences that satisfy certain thresholds. The highest ranking candidate sub-sequences are provided as recommended event sequences. These recommended event sequences represent events to be performed, such as by a user of a client device or automatically by the client device or other systems, in order to complete performance of the current instance of the structured process in a manner that satisfies one or more parameters (e.g., accuracy, customer satisfaction, etc.) and that is faster and more efficient than relying on the user or the system to determine the events on their own.

In a particular aspect, a method for automated action recommendation for structured processes includes obtaining, by one or more processors, event data corresponding to a partial performance of a structured process. The event data includes parameters of one or more events that have been performed during the partial performance as part of an event sequence to complete the structured process. The method also includes providing, by the one or more processors, at least some of multiple features extracted from the event data as input data to one or more ML models to assign the partial performance to an assigned cluster of multiple clusters. The one or more ML models are configured to assign input feature sets to the multiple clusters based on relationships between the input feature sets and features of members of the multiple clusters. The method includes generating, by the one or more processors, at least one recommended event sequence based on multiple event sequences that correspond to the assigned cluster and based on a current event level derived from the event data. Each event sequence of the at least one recommended event sequence includes one or more actions to be performed to complete the structured process. The method further includes outputting, by the one or more processors, the at least one recommended event sequence.

In another particular aspect, a system for automated action recommendation for structured processes includes a memory and one or more processors communicatively coupled to the memory. The one or more processors are configured to obtain event data corresponding to a partial performance of a structured process. The event data includes parameters of one or more events that have been performed during the partial performance as part of an event sequence to complete the structured process. The one or more processors are also configured to provide at least some of multiple features extracted from the event data as input data to one or more ML models to assign the partial performance to an assigned cluster of multiple clusters. The one or more ML models are configured to assign input feature sets to the multiple clusters based on relationships between the input feature sets and features of members of the multiple clusters. The one or more processors are configured to generate at least one recommended event sequence based on multiple event sequences that correspond to the assigned cluster and based on a current event level derived from the event data. Each event sequence of the at least one recommended event sequence includes one or more actions to be performed to complete the structured process. The one or more processors are further configured to output the at least one recommended event sequence.

In another particular aspect, a non-transitory computer-readable storage medium stores instructions that, when executed by one or more processors, cause the one or more processors to perform operations for automated action recommendation for structured processes. The operations include obtaining event data corresponding to a partial performance of a structured process. The event data includes parameters of one or more events that have been performed during the partial performance as part of an event sequence to complete the structured process. The operations also include providing at least some of multiple features extracted from the event data as input data to one or more ML models to assign the partial performance to an assigned cluster of multiple clusters. The one or more ML models are configured to assign input feature sets to the multiple clusters based on relationships between the input feature sets and features of members of the multiple clusters. The operations include generating at least one recommended event sequence based on multiple event sequences that correspond to the assigned cluster and based on a current event level derived from the event data. Each event sequence of the at least one recommended event sequence includes one or more actions to be performed to complete the structured process. The operations further include outputting the at least one recommended event sequence.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an example of a system that supports automated action recommendation for structured processes according to one or more aspects;

FIG. 2 is a flow diagram illustrating an example of a structured process according to one or more aspects;

FIG. 3 is a process flow diagram of an example of operations for automated event sequence recommendation for electronic processing of insurance claims according to one or more aspects;

FIG. 4 is a block diagram of an example of an example of a system for automated event sequence recommendation for electronic processing of insurance claims according to one or more aspects;

FIG. 5 is a process flow diagram of an example of training and deployment of the intelligent recommender (e.g., an intelligent recommendation engine) of FIG. 4;

FIG. 6 shows examples of feature variance resulting from affinity analysis according to one or more aspects;

FIG. 7 is a block diagram of an example of a system for supporting a channelized reflexive virtual agent that supports electronic processing of insurance claims according to one or more aspects; and

FIG. 8 is a flow diagram illustrating an example of a method for automated action recommendation for structured processes according to one or more aspects.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

### DETAILED DESCRIPTION

Aspects of the present disclosure provide systems, methods, apparatus, and computer-readable storage media that support automated action recommendation for structured processes. Aspects described herein leverage artificial intelligence (AI) and machine learning (ML) algorithms and/or models to assign features corresponding to previously performed event sequences into clusters based on underlying feature relationships using unsupervised learning. In some examples, a system that provides recommendation services receives event data that indicates a current or new instance of a structured process, such as an insurance handling process or a network resources allocation process, as non-limiting examples, and the system assigns the instance to one of multiple clusters based on extracted features. Because the ML algorithms/models are trained using historical event data, members of each cluster correspond to various event sequences that were performed during previous instances of the structured process. The event sequences that correspond to members of the assigned cluster are used to generate candidate event sequences using data mining, latticing, and other techniques. In some examples, the data mining includes reducing the total number of candidate event sequences based on scores determined from application of associative rules and, after the reduction, generating multiple incremental candidate sub-sequences. The candidate sub-sequences can be pruned and filtered based on a current event level of the current or new instance, as well as based on corresponding associate rule scores, to generate an incremental ordering of candidate sub-sequences that satisfy certain thresholds. The highest ranking candidate sub-sequences are provided as recommended event sequences that represent events to be performed, such as by a user of a client device or automatically by the client device or other systems, in order to complete performance of the current instance of the structured process.

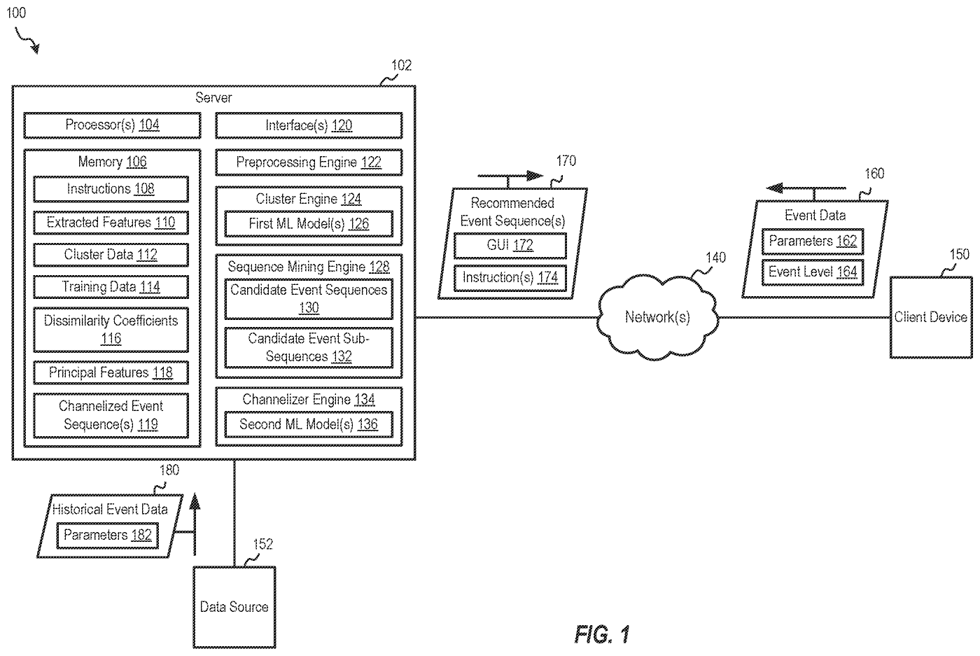

Referring to FIG. 1, an example of a system for automated action recommendation for structured processes according to one or more aspects is shown as a system 100. As shown in FIG. 1, the system 100 includes a server 102, a client device 150, a data source 152, and one or more networks 140. In some implementations, the system 100 may include additional components that are not shown in FIG. 1, such as one or more additional client devices, additional data sources, and/or a database configured to store extracted features, cluster data, event sequences, model parameters, or a combination thereof, as non-limiting examples.

The server 102 may be configured to recommend actions (e.g., event sequences) to complete a structured process based on event data related to initiation or partial performance of the structured process. Although described as a server 102, in some other implementations, the system 100 may instead include a desktop computing device, a laptop computing device, a personal computing device, a tablet computing device, a mobile device (e.g., a smart phone, a tablet, a personal digital assistant (PDA), a wearable device, and the like), a server, a virtual reality (VR) device, an augmented reality (AR) device, an extended reality (XR) device, a vehicle (or a component thereof), an entertainment system, other computing devices, or a combination thereof, as non-limiting examples. The server 102 includes one or more processors 104, a memory 106, one or more communication interfaces 120, a preprocessing engine 122, a cluster engine 124, a sequence mining engine 128, and a channelizer engine 134. In some other implementations, one or more of the components are optional, one or more additional components are included in the server 102, or both. It is noted that functionalities described with reference to the server 102 are provided for purposes of illustration, rather than by way of limitation, and that the exemplary functionalities described herein may be provided via other types of computing resource deployments. For example, in some implementations, computing resources and functionality described in connection with the server 102 may be provided in a distributed system using multiple servers or other computing devices, or in a cloud-based system using computing resources and functionality provided by a cloud-based environment that is accessible over a network, such as the one of the one or more networks 140. To illustrate, one or more operations described herein with reference to the server 102 may be performed by one or more servers or a cloud-based system that communicates with one or more client or user devices.

The one or more processors 104 includes one or more microcontrollers, application specific integrated circuits (ASICs), field programmable gate arrays (FPGAs), central processing units (CPUs) having one or more processing cores, or other circuitry and logic configured to facilitate the operations of the server 102 in accordance with aspects of the present disclosure. The memory 106 includes random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. Software configured to facilitate operations and functionality of the server 102 are stored in the memory 106 as instructions 108 that, when executed by the one or more processors 104, cause the one or more processors 104 to perform the operations described herein with respect to the server 102, as described in more detail below. Additionally, the memory 106 is configured to store data and information, such as extracted features 110, cluster data 112, training data 114, dissimilarity coefficients 116, principal features 118, and one or more channelized event sequences (referred to herein as “channelized event sequences 119”). Illustrative aspects of the extracted features 110, the cluster data 112, the training data 114, the dissimilarity coefficients 116, the principal features 118, and the channelized event sequences 119 are described in more detail below.

The one or more communication interfaces 120 are configured to communicatively couple the server 102 to the one or more networks 140 via wired or wireless communication links established according to one or more communication protocols or standards (e.g., an Ethernet protocol, a transmission control protocol/internet protocol (TCP/IP), an Institute of Electrical and Electronics Engineers (IEEE) 802.11 protocol, an IEEE 802.16 protocol, a 3rd Generation (3G) communication standard, a 4th Generation (4G)/long term evolution (LTE) communication standard, a 5th Generation (5G) communication standard, and the like). In some implementations, the server 102 includes one or more input/output (I/O) devices that include one or more display devices, a keyboard, a stylus, one or more touchscreens, a mouse, a trackpad, a microphone, a camera, one or more speakers, haptic feedback devices, or other types of devices that enable a user to receive information from or provide information to the server 102. In some implementations, the server 102 is coupled to a display device, such as a monitor, a display (e.g., a liquid crystal display (LCD) or the like), a touch screen, a projector, a virtual reality (VR) display, an augmented reality (AR) display, an extended reality (XR) display, or the like. In some other implementations, the display device is included in or integrated in the server 102. In some other implementations, the server 102 is communicatively coupled to one or more client devices that include or are coupled to respective display devices.

The preprocessing engine 122 is configured to preprocess (e.g., perform one or more preprocessing operations on) received data, such as current event data or historical event data, to convert the received data to a form that can be used by the engines and ML models described herein. Particular examples of the preprocessing operations include removing empty data sets or values, validating parameters of events included in received data, converting at least a portion of the received data to a common format, other preprocessing operations, or a combination thereof. In some implementations, the preprocessing engine 122 is further configured to discard features that are not included in primary features identified based on an affinity analysis performed on historical event data by the preprocessing engine 122 and/or the processor 104, as further described herein.

The cluster engine 124 is configured to assign input feature sets that represent events performed during a partial performance of a structured process to one of multiple clusters of feature sets based on underlying relationships between the input features sets and the features sets that are members of the multiple clusters. The clusters are initially determined by clustering feature sets extracted from historical event data related to past performance of the structured process. As a particular, non-limiting example, the cluster engine 124 clusters thirty feature sets extracted from historical event data into ten clusters based on the similarities and differences of the values of the extracted feature sets, and after the initial clustering, the cluster engine 124 may assign an input feature set to one of the ten clusters that has members that are most similar to the input feature set based on underlying relationships learned from the initial clustering operations. The cluster engine 124 may be configured to perform clustering according to one or more clustering algorithms, such as K-modes, K-means, means-shift clustering, density-based spatial clustering of applications with noise (DBSCAN), expectation-maximization (EM) clustering using Gaussian mixture models (GMM), hierarchical clustering, agglomerative clustering, spectral clustering, balanced iterative reducing and clustering (BIRCH), ordering points to identify the clustering structure (OPTICS), or the like.

In some implementations, the cluster engine 124 includes and/or integrates, or has access to, one or more ML models (referred to herein as “first ML models 126”) that are configured to perform the clustering operations. The first ML models 126 may include or correspond to one or more neural networks (NNs), such as restricted Boltzmann machines (RBMs), variational autoencoders (VAEs), generative adversarial networks (GANs), singular value decomposition (SVD) models, principal component analysis (PCA) models, or the like. In other implementations, the first ML models 126 may include or correspond to other types of ML models, such as agglomerative hierarchal clustering (AHC) models, anomaly detection models, k-nearest neighbors (KNN) models, K-Means clustering models, Density-Based Spatial Clustering of Applications with Noise (DBSCAN) models, Deep Convolutional GANs (DCGANs), Gaussian mixture models (GMMs), Apriori algorithm for association rules, or the like. The first ML models 126 may be trained using unsupervised learning to cluster input feature sets into one of multiple clusters based on underlying relationships between feature sets of members of the multiple clusters. The input feature sets include extracted features from historical event data representing event sequences (e.g., actions) performed during past (e.g., previous or prior) performances of a structured process. The structured process may be performed by client devices such as the client device 150, as further described herein. As a particular example, the first ML models 126 are trained to perform K-modes clustering on categorical features corresponding to event sequences. In some such implementations, initial seeds for the clustering are selected based on dissimilarity scores, as further described herein. As another example, the first ML models 126 may be trained to perform K-means clustering on numerical features corresponding to event sequences. Although implementations described herein include both training and deployment of the first ML models 126 by the server 102, in some other implementations, the first ML models 126 may be trained by one or more other devices and ML model parameters may be provided to the server 102 to deploy the first ML models 126 at the server 102. Thus, in at least some implementations, device(s) that train the first ML models 126 are not the same as device(s) that host the first ML models 126 to support the action recommendation described herein.

The sequence mining engine 128 is configured to perform data mining on event sequences that correspond to selected clusters to generate recommended event sequences for completing performance of a structured process. To illustrate, the sequence mining engine 128 may be configured to extract one or more candidate event sequences (e.g., patterns) that correspond to members of a selected cluster and to generate incremental candidate sub-sequences (e.g., sub-patterns) that correspond to sequences of events that may complete the structured process. The process of extracting sequences and generating incremental candidate event sub-sequences may also be referred to as incremental latticing, such as extracting lattices and generating incremental sub-lattices. The sequence mining engine 128 may be configured to reduce the number of candidate event sub-sequences based on a current event level of events that resulted in the selected cluster, apply one or more associative rules to score the candidate event sub-sequences according to one or more association scores, and filter (e.g., discard) candidate event sub-sequences having scores that fail to satisfy one or more thresholds. This process is also referred to as interlacing searching, pruning, pattern mining, and incremental latticing, to generate a reduced set of candidate event sub-sequences (e.g., sub-lattices) representing events that can be performed to complete the structured process. In some implementations, the sequence mining engine 128 may be further configured to rank the remaining candidate event sub-sequences, such as based on the association scores, and to output a particular number of highest ranked candidate event sub-sequences as recommended event sequences.

The channelizer engine 134 is configured to channelize the sub-sequences (e.g., those generated by the sequence mining engine 128). For example, the structured process may be performed as a multi-layered process, and each layer may correspond to a different channel. The channelizer engine 134 may be configured to convert the candidate event sub-sequences to channelized sub-sequences that each correspond to a respective channel, and these channelized sub-sequences may be output as recommended channelized event sequences to be performed by different ML or AI services that are configured to support performance the multiple layers of the structured process by a channelized reflexive virtual agent, as further described herein.

In some implementations, the channelizer engine 134 includes or integrates, or has access to, one or more ML models (referred to herein as “second ML models 136”) that are configured to perform the channelizing operations. The second ML models 136 may include or correspond to one or more NNs, such as MLP networks, RBMs, VAEs, GANs, SVD NNs, or the like. In other implementations, the second ML models 136 include or correspond to other types of ML models, such as AHCs, anomaly detection models, KNN models, k-means models, DBSCAN models, DCGANs, GMMs, Apriori algorithms, or the like. The second ML models 136 are trained using unsupervised learning to perform classification on input features that represent event sequences to classify the event sequences (or portions thereof) as belonging to one of multiple channels. The input feature sets include extracted features from historical event data representing event sequences (e.g., actions) performed during past (e.g., previous or prior) performances of a structured process, and the feature sets are labeled based on the corresponding channel to which the event sequence (or portion thereof) is assigned. Although implementations described herein include both training and deployment of the second ML models 136 by the server 102, in some other implementations, the second ML models 136 may be trained by one or more other devices and ML model parameters may be provided to the server 102 to deploy the second ML models 136 at the server 102. Thus, in at least some implementations, device(s) that train the second ML models 136 are not the same as device(s) that host the second ML models 136 to support the action recommendation described herein.

The client device 150 is configured to communicate with the server 102 via the one or more networks 140 to provide event data related to a structured process for use by the server 102 to recommend one or more actions, such as one or more recommended event sequences, for completing performance of the structured process. The client device 150 may include or correspond to a computing device, such as a desktop computing device, a server, a laptop computing device, a personal computing device, a tablet computing device, a mobile device (e.g., a smart phone, a tablet, a PDA, a wearable device, and the like), a VR device, an AR device, an XR device, a vehicle (or component(s) thereof), an entertainment system, another computing device, or a combination thereof, as non-limiting examples. The client device 150 may include a processor, one or more communication interfaces, and a memory that stores instructions that, when executed by the processor, cause the processor to perform the operations described herein, similar to the server 102.

The data source 152 is configured to be accessible to the server 102 via the one or more networks 140 to enable retrieval of data, such as historical event data, related to past performances of the structured process. The data source 152 may include or correspond to a database, cloud storage, external storage, or the like, or to a computing device, such as a desktop computing device, a server, a laptop computing device, a personal computing device, another computing device, or a combination thereof, as non-limiting examples. In implementations in which the data source 152 is a computing device, the data source 152 may include a processor, one or more communication interfaces, and a memory that stores instructions that, when executed by the processor, cause the processor to perform the operations described herein, similar to the server 102.

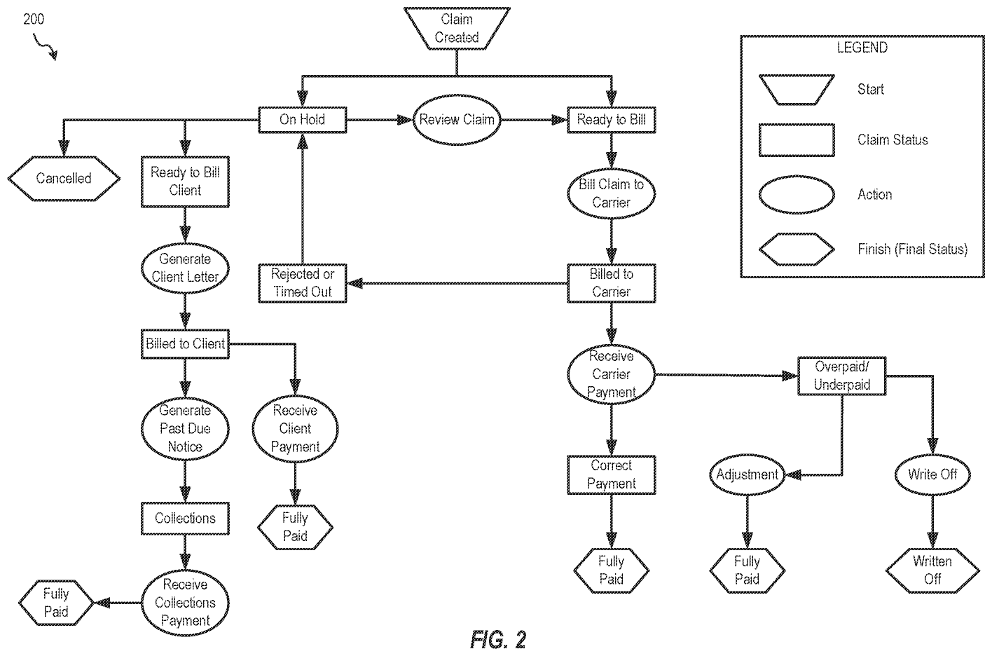

During operation of the system 100, the server 102 deploys the first ML models 126 to provide automated intelligent action recommendation services to client devices. For example, the client device 150 may be configured to support performance a structured process, and based on event data 160 that indicates initiation or partial performance of a new instance of the structured process, the server 102 recommends one or more event sequences to be performed to complete the structured process. A structured process refers to any formally defined and standardized sequence of tasks that begins with a start event and ends in one or more end events. Performance of at least some of the tasks results in one or more defined outcomes (e.g., end events). For example, if the structured process is arranged as a flow chart, there may be one or more vertical paths through the structured process that result in one or more outcomes. Additionally, there may be horizontal paths from one or more nodes or entries in the flow chart that traverse from one vertical path to another vertical path (or that include a path with both vertical and horizontal components). Such horizontal paths may result from optional or conditional decisions or other situations that cause traversal along one vertical path to branch off. The tasks can be performed automatically by the client device 150 or can require user input from a user of the client device 150, or both. Examples of structured processes include a loan approval process, an insurance claim handling process, a new user addition process, an account transfer process, a document generation process, a maintenance or repair process, a system configuration process, a system upgrade process, or any other type of defined or standardized process that can be performed by the client device 150. An example of a particular structured process is described further herein with reference to FIG. 2. Although particular examples provided herein are described in the context of an electronic insurance claim handling process, the aspects described herein are applicable to any type of structured process. To support the automated action recommendation services in some implementations, the server 102 deploys and maintains one or more types of ML models, such as the first ML models 126 and, optionally, the second ML models 136. In some implementations, the server 102 trains the various ML models to perform the operations described herein. In some other implementations, some or all of the ML models are trained at other devices or locations, and the parameters of the trained ML models are provided (e.g., transmitted, downloaded, or otherwise stored at or accessible to) the server 102 for implementing the ML models.

In implementations in which the server 102 trains the first ML models 126, the server 102 obtains (e.g., retrieves) historical event data 180 from the data source 152. The historical event data 180 corresponds to one or more past performances of the structured process performed by the client device 150. For example, the historical event data 180 can include parameters 182 of events (e.g., tasks, actions, etc.) that have been performed during one or more past performances (e.g., instances) of the structured process. As an illustrative example, the historical event data 180 indicates that a first instance of the structured process included creating a claim, settlement of a claim, receiving payment from the client, and closing a fully paid claim, and that a second instance of the structured process included creating a claim, reviewing the claim, billing the claim to a carrier, receiving payment from the carrier, determining that the claim was underpaid, writing off the difference, and closing a written off claim. In this example, the parameters 182 may include an amount of a claim, a time before a claim was reviewed, the client that corresponds to the claim, the carrier that corresponds to the claim, an amount of time between billing and payment, a difference between a billed amount and a received amount, other parameters, or a combination thereof. As another illustrative example, the historical event data 180 indicates that an instance of the structured process included monitoring incoming data rates for a particular data stream, determining that at least one incoming data rate fails to satisfy a threshold, comparing a priority of the particular stream to other concurrent data streams, determining that the priority is a highest ranked priority, and requisitioning additional bandwidth resources to be assigned to the particular data stream, and the parameters 182 may include incoming data rates, data stream priorities, thresholds, available bandwidth resources, and the like.

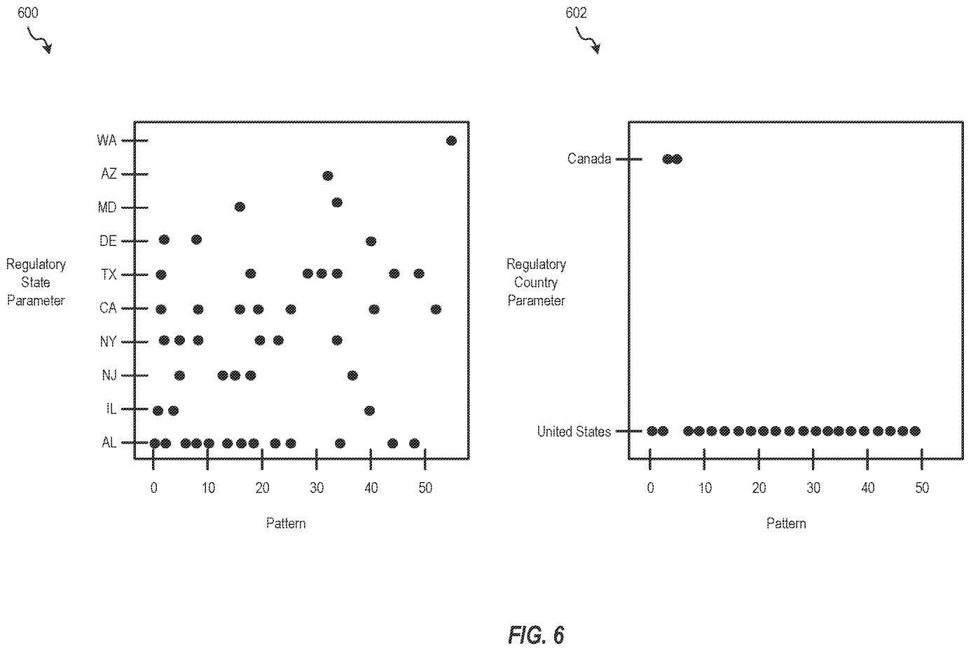

In such implementations in which the server 102 trains the first ML models 126, the server 102 provides the historical event data 180 to the preprocessing engine 122 to perform preprocessing on the historical event data 180. The preprocessing operations include one or more operations for formatting the historical event data 180, removing unusable entries, filling in missing entries, or otherwise preparing the historical event data 180 to be in a form that is useful to the first ML models 126. As an example, the preprocessing operations may include validating the parameters 182, such as comparing the parameters 182 to acceptable values or value ranges associated with the structured process. As another example, the preprocessing operations may include converting at least a portion of the historical event data 180 to a common format, such as a format that is used by input to the first ML models 126. After the preprocessing (or included as a next step of the preprocessing), the server 102 may extract features from the historical event data 180 to generate training data 114 for use in training the first ML models 126. The extracted features indicate the events represented by the historical event data 180, the parameters 182, other information, or a combination thereof. In some implementations, the server 102 performs an affinity analysis on the extracted features to identify a subset of the features for which variance satisfies a threshold as the principal features 118. The features having less variance (e.g., that do not satisfy a threshold) are considered to have less effect on the selection of events during performance of the structured process, and therefore may be discarded to reduce the size of the features to be used as the training data 114. For example, only the extracted features types that match the principal features 118 are retained (e.g., the other extracted features are discarded) and used to generate the training data 114. Examples of feature variance and feature reduction are further described herein with reference to FIG. 6. After performing the affinity analysis and reducing the extracted features based on the principal features 118, the remaining features are used to generate the training data 114, and the server 102 provides the training data 114 to the cluster engine 124 to train the first ML models 126. In some implementations, the training data 114 is partitioned into training data, test data, and validation data for the purposes of training such that the first ML models 126 are tested after training to ensure one or more parameters, such as accuracy, speed, or the like, are satisfied by the trained first ML models 126, or else the first ML models 126 may be further trained before deployment.

The first ML models 126 are trained to perform unsupervised learning-based clustering to assign the extracted features (and the corresponding event sequences from which the features are extracted from) to multiple clusters. Because the feature sets are not labeled with clusters, the first ML models 126 are trained to perform clustering using unsupervised learning. In some implementations, the type of clustering performed by the first ML models 126 is K-modes clustering. In some other implementations, the first ML models 126 are trained to perform other types of clustering, such as K-means clustering as a non-limiting example. The clustering is performed based on one or more parameters that are preconfigured at the server 102 or selected by a user, such as an initial seeding type. In some implementations in which K-modes clustering is used, the initial seeding is determined based on the dissimilarity coefficients 116 between candidate members of the multiple clusters. In such implementations, the server 102 determines the dissimilarity coefficients 116 that represent dissimilarity between one or more of the extracted feature sets that make up the training data 114. The initial centroids are determined based on the ‘Huang’ initial seeding method using the dissimilarity coefficients. Determining the initial seeding artefacts in this manner creates clusters based on frequency of vertical patterns and horizontal event sequences in the historical event data 180. This ‘Huang’ initial seeding method works particularly well in environments in which the historical event data 180 contains a mix of both ordered discrete (e.g., ordinal) data and unorder discrete (e.g., nominal) data. In some other implementations, other types of initial seeding are used, such as randomized initial seeding in implementations in which K-means clustering is used. In some implementations, the number of clusters are determined using Elbow technique. Training the first ML models 126 in this manner results in the assignment of the feature sets represented by the training data 114 to corresponding clusters of a group of clusters (e.g., multiple clusters) based on underlying relationships between the features that are learned by the first ML models 126. The resultant clusters, including the number of clusters and the members of each cluster, are stored at the memory 106 as the cluster data 112 for use by the first ML models 126 during post-training operations.

After training the first ML models 126 (if training occurs at the server 102) or after obtaining ML model parameters from another source, the server 102 implements the trained first ML models 126 using the ML model parameters. Implementing and maintaining the first ML models 126 enables the server 102 to support automated action recommendation services, such as to the client device 150. When the client device 150 utilizes the automated action recommendation services, the client device 150 sends the event data 160 to the server 102. The event data 160 corresponds to partial performance (e.g., a partially complete or fully incomplete instance) of the structured process performed by the client device 150. For example, the event data 160 indicates or includes parameters 162 of events (e.g., tasks, actions, etc.) that have been performed during the partial performance of the structured process and an event level 164 (e.g., a current event level) that represents a current level of the structured process that has been reached during the partial performance. As an illustrative example, the event data 160 may indicate that partial performance includes creating a claim, reviewing the claim, and billing the claim to a carrier. In this example, the parameters 162 may include an amount of the claim, a time before the claim was reviewed, the client that corresponds to the claim, the carrier that corresponds to the claim, other parameters, or a combination thereof, and the event level 164 may represent a waiting for payment status (e.g., a collections level, as opposed to a billing level). As another illustrative example, the event data 160 may indicate that the partial performance includes monitoring incoming data rates for a particular data stream and determining that at least one incoming data rate fails to satisfy a threshold, the parameters 162 may include incoming data rates, thresholds, and the like, and the event level 164 may represent a prioritization level (e.g., an internal comparing and processing level). Although shown as part of the event data 160, in some other implementations, the event level 164 is not included in the event data 160 but is capable of being derived from the event data 160, such as by identifying which parameters 162 are included in the event data 160, identifying layers of the structured process that have associated parameters included in the parameters 162, or the like.

The server 102 provides the event data 160 to the preprocessing engine 122 to perform one or more preprocessing operations on the event data 160 to preprocess the event data 160 prior to extracting the extracted features 110. The preprocessing operations include one or more operations for formatting the event data 160, removing unusable entries, filling in missing entries, or otherwise preparing the event data 160 to be in a form that is useful to the first ML models 126. As an example, the preprocessing operations may include validating the parameters 162, such as comparing the parameters 162 to acceptable values or value ranges associated with the structured process to ensure that no unexpected or incorrect events are indicated by the event data 160. As another example, the preprocessing operations may include converting at least a portion of the event data 160 to a common format, such as a format that is used by input to the first ML models 126. The preprocessing performed by the preprocessing engine 122 may also include feature extraction. For example, the preprocessing engine 122 (or the processor 104), after performing the above-described preprocessing, extracts features from the event data 160 to generate the extracted features 110. The extracted features 110 indicate events represented by the event data 160, the parameters 162, other information, or a combination thereof. In some implementations, the preprocessing engine 122 (or the processor 104) performs feature reduction on the extracted features 110 to reduce the number of features, thereby reducing a storage footprint of the extracted features 110 and processing resources utilized to implement and maintain the first ML models 126. For example, feature types that do not correspond to the principal features 118 (e.g., a subset of features identified based on performance of an affinity analysis on features extracted from the historical event data 180) may be discarded, such that the remaining features of the extracted features 110 only include feature types that match the principal features 118.

The cluster engine 124 provides at least some of the extracted features 110 (e.g., the remaining features after the feature reduction) as input data to the first ML models 126 to cause the first ML models 126 to assign the extracted features 110 (e.g., an input feature set) to one of the multiple clusters indicated by the cluster data 112. For example, if the cluster data 112 indicates that there are ten clusters, the first ML models 126 assigns the input feature set to the cluster to which the input feature set has the most similarity based on the underlying relationships between features learned by the first ML models 126 during the clustering of the training. The assigned cluster may have one or more other members besides the newly assigned input feature set, and each member of the assigned cluster corresponds to an event sequence indicated by the historical event data 180. As such, the cluster engine 124 identifies the event sequences corresponding to members of the assigned cluster and provide these event sequences as input to the sequence mining engine 128.

The sequence mining engine 128 may receive the event sequences provided by the cluster engine 124, or the cluster engine 124 may provide an indication of the assigned cluster and the sequence mining engine 128 may extract the corresponding event sequences from the cluster data 112. The sequence mining engine 128 identifies the event sequences as candidate event sequences 130 (e.g., the sequence mining engine 128 generates the candidate event sequences 130 from the cluster data 112 or based on input from the cluster engine 124) to be used to mine recommended event sequences using one or more data mining operations. The sequence mining engine 128 may discard (e.g., not include in the candidate event sequences 130) event sequences that have one or more associative rule scores that fail to satisfy one or more thresholds. In some implementations, the one or more scores include a support score, a confidence score, and a lift score, and the one or more thresholds may include a common threshold, such as a 50 percentile score, or different thresholds for different scores. The data mining includes, after identifying the candidate event sequences 130, generating multiple incremental candidate event sub-sequences (referred to herein as “candidate event sub-sequences 132”) based on the candidate event sequences 130. For example, multiple different combinations of candidate event sub-sequences are created in an incremental order from a particular candidate event sequence, and the candidate event sub-sequences 132 include an incremental ordering of the unique event sub-sequences. The data mining includes pruning the candidate event sub-sequences 132 based on the event level 164. For example, any candidate event sub-sequence that does not include the event level 164 or that does not have one or more antecedents (e.g., one or more previous events in the candidate event sub-sequence) that matches events indicated by the event data 160 and/or the parameters 162 may be pruned (e.g., discarded). The data mining may also include filtering the candidate event sub-sequences 132 to remove candidate event sub-sequences that do not have associative rule scores that satisfy the one or more thresholds. For example, the sequence mining engine 128 determines one or more scores for the candidate event sub-sequences 132 by applying associative rules to determine the scores, such as support scores, confidence scores, and lift scores, and the sequence mining engine 128 filters (e.g., prunes or discards) candidate event sub-sequences that have scores that fail to satisfy the one or more thresholds. After these pruning and filtering operations, the candidate event sub-sequences 132 that remain represent a list of unique candidate event sub-sequences that have associative rule scores that satisfy the one or more thresholds and that include the event level 164 and the proper antecedents. The sequence mining engine 128 may then rank the candidate event sub-sequences 132 based on the corresponding associative rule scores and output a particular number of highest ranked candidate event sub-sequences as at least one recommended event sequence (referred to herein as “recommended event sequences 170”). For example, the sequence mining engine 128 outputs the highest ranked candidate event sub-sequence or a particular number of multiple highest ranked candidate event sub-sequences as the recommended event sequences 170. The particular number may be preprogrammed, based on user input, based on a target parameter (e.g., accuracy of recommendations), or the like.

The server 102 may output the recommended event sequences 170 to the client device 150, and optionally to other devices, to provide recommendations for actions to perform to complete the structured process. For example, each event sequence of the recommended event sequences 170 includes one or more events to be performed to complete the structured process. In some implementations, outputting the recommended event sequences 170 includes sending the recommended event sequences 170 to the client device 150 to be displayed in a graphical user interface (GUI) 172. For example, the server 102 may initiate display of the GUI 172 at the client device 150, and the GUI 172 includes the recommended event sequences 170. To further illustrate, the GUI 172 may include a dashboard that displays a user selected event sequence of the recommended event sequences 170 (e.g., actions to be performed, statuses to be monitored, etc.), and optionally related information such as associate rule scores, to enable completion of the structured process. Additionally or alternatively, outputting the recommended event sequences 170 may include sending instructions 174 to the client device 150 (or to other devices) to cause the client device 150 to automatically perform one or more actions of the recommended event sequences 170. For example, if the structured process is a process to control a robot or a drone, the instructions 174 may include instructions to capture measurements from a particular sensor, to move the robot to a particular location, to actuate a motor to rotate an arm, or the like.

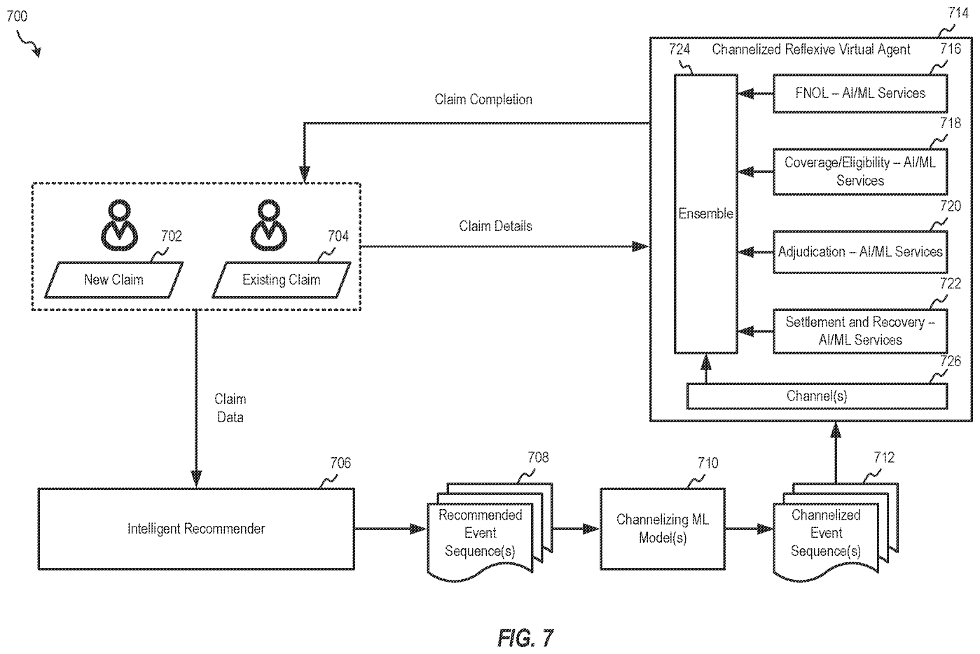

In some implementations, the server 102 is configured to support channelized reflexive virtualization (CRV) by providing channelized sets of recommended event sequences to be utilized with ensembled AI/ML services at each layer of the structured process, such as by supporting operation of a channelized reflexive virtual agent. In these implementations, the server 102 provides the recommended event sequences 170 as input data to the channelizer engine 134. The channelizer engine 134 provides the recommended event sequences 170 as input to the second ML models 136 to generate the channelized event sequences 119. The channels of the channelized event sequences 119 may correspond to layers of the structured process. As an example, the structured process may be an electronic insurance claims handling process, and the channels may correspond to a first notice of loss (FNOL) layer (e.g., an initial reporting layer), a coverage/eligibility layer, an adjudication layer, and a settlement and recovery layer. Channelizing the recommended event sequences 170 may divide the event sequences into events that correspond to the different layers. The second ML models 136 are trained to channelize event sequences based on a supervised learning processes, such as training a classifier based on labeled training data (e.g., historical event sequences or sub-sequences that are labeled by channel). The channelized event sequences 119 output by the second ML models 136 are provided to a channelized reflexive virtual agent to automatically respond to or manage performance of the structured process via layer-specific ML and AI models. The channelized reflexive virtual agent is supported at the server 102, and in such implementations, the server initiates performance of one or more operations based on the channelized event sequences 119 instead of outputting the recommended event sequences 170. Additional details of channelizing event sequences and CRV are further described herein with reference to FIG. 7.

In a particular implementation, a system (e.g., 100) for automated action recommendation for structured processes is disclosed. The system includes a memory (e.g., 106) and one or more processors (e.g., 104) communicatively coupled to the memory. The one or more processors are configured to obtain event data (e.g., 160) corresponding to a partial performance of a structured process. The event data includes parameters (e.g., 162) of one or more events that have been performed during the partial performance as part of an event sequence to complete the structured process. The one or more processors are also configured to provide at least some of multiple features (e.g., 110) extracted from the event data as input data to one or more ML models (e.g., 126) to assign the partial performance to an assigned cluster of multiple clusters (e.g., represented by 112). The one or more ML models are configured to assign input feature sets to the multiple clusters based on relationships between the input feature sets and features of members of the multiple clusters. The one or more processors are configured to generate at least one recommended event sequence (e.g., 170) based on multiple event sequences that correspond to the assigned cluster and based on a current event level (e.g., 164) derived from the event data. Each event sequence of the at least one recommended event sequence includes one or more actions to be performed to complete the structured process. The one or more processors are further configured to output the at least one recommended event sequence.

As described above, the system 100 supports automated action recommendation for structured processes. The recommendation services provided by the system 100 are provided using fewer processing resources and in a shorter time period than other types of recommendation services. For example, the sequence mining engine 128 may reduce the number of candidate event sequences 130 and the candidate event sub-sequences 132 through application of one or more associative rules, resulting in a smaller amount of sequences to search through for the recommended event sequences 170. Reducing this amount of sequences (e.g., the search space) reduces the amount of time to generate recommendations and the amount of processing and memory resources utilized by the server 102. Additionally, by initially grouping event sequences (e.g., based on extracted features) into clusters using unsupervised learning, the cluster engine 124 enables the server to learn similarities between previously performed event sequences that may not be obvious to human analysts, at least without significant time and resources devoted to analyzing a large quantity of event sequences. Additionally, some implementations described above perform channelization on the recommended event sequences 170 to support CRV and enable use of a channelized reflexive virtual agent to manage performance of a structured process, as further described herein with reference to FIG. 7.

Referring to FIG. 2, a flow diagram of an example of a structured process according to one or more aspects is shown as a structured process 200. In the particular example shown in FIG. 2, the structure process is an electronic insurance claim processing and/or handling process. Although particular details described herein are described in the context of electronic insurance claim handling processes, the disclosure is not limited to this particular structured process. For example, the aspects described herein may be applied to performance of any type of structured process, such as a loan approval process, a new user addition process, an account transfer process, a document generation process, a maintenance or repair process, a system configuration process, a system upgrade process, or the like.

A structured process may refer to any formally defined and standardized sequence of tasks that begins with a start event and ends in one or more end events. Performance of at least some of the tasks results in one or more defined outcomes (e.g., end events). For example, if the structured process is arranged as a flow chart, there may be one or more vertical paths through the structured process that result in one or more outcomes. Additionally, there may be horizontal paths from one or more nodes or entries in the flow chart that traverse from one vertical path to another vertical path (or that include a path with both vertical and horizontal components). Such horizontal paths may result from optional or conditional decisions or other situations that cause traversal along one vertical path to branch off. As shown in FIG. 2, the structured process 200 includes multiple operations in a process flow that proceeds in both vertical and horizontal directions based on a status of an insurance claim being handled. Operations to be performed during the structured process 200 are shown in ovals, statuses of the claim that may be detected are shown in boxes, and end results of the structured process 200 are shown in hexagons.

The structured process 200 may include multiple sequences (e.g., paths) that include traversing nodes in a vertical direction or in a vertical direction and a horizontal direction to reach one of the multiple end events. As an illustrative example, a first process includes starting with the start event of creating a claim, proceeding vertically to ready to bill status, proceeding vertically to billing the claim to a carrier, proceeding vertically to billed to carrier status, proceeding vertically to receiving payment from the carrier, proceeding vertically to correct payment status, and proceeding vertically to the end event of the claim being fully paid. As another example, a second process includes starting with the start event of creating a claim, proceeding vertically to ready to bill status, proceeding vertically to billing the claim to a carrier, proceeding vertically to billed to carrier status, proceeding vertically to receiving payment from the carrier, proceeding horizontally to overpaid/underpaid status, proceeding vertically to making an adjustment to the payment, and proceeding vertically to the end event of the claim being fully paid. As another example, a third process includes starting with the start event of creating a claim, proceeding vertically to ready to bill status, proceeding vertically to billing the claim to a carrier, proceeding horizontally to rejected or timed out status, proceeding horizontally to on hold status, proceeding horizontally to ready to bill client status, proceeding vertically to generating a client letter, proceeding horizontally to receiving payment from the client, and proceeding vertically to the end event of the claim being fully paid. As can be appreciated from these examples, multiple different event sequences (e.g., paths) are possible for the structured process 200, including proceeding vertically or proceeding both vertically and horizontally from node to node until reaching one of the multiple end events. Reducing the number of possible sequences and recommending actions to perform based on a current event level may significantly reduce the amount of time and resources spent to complete performance of the structured process 200.

Structured processes can be more complex than the example shown in FIG. 2, and thus may represent a complex problem for providing automated action recommendation services. For example, the complexity may result from or be affected by factors such as: early learning of all vertical pattern variants and horizontal event sequences during the structured process lifecycle from vast historical event data with various possible combination; the dynamic nature of the horizontal event sequences during the structured process at each horizontal event node increases the vertical pattern variants count and thus the complexity of segmenting them into groups; identification of direct/indirect impact of attributes (e.g., features) on vertical patterns; identification of principal attributes (e.g., principal features) from a large quantity of multidimensional features (e.g., ˜200 features in some structured processes) using some instrumental approach to avoid drip of any essential attributes during solutioning; the similarity nature between complaint and non-complaint patterns (e.g., event sequences) may ˜80% for some structured processes, which increases the complexity in the pattern reduction procedure; and exploration of appropriate methodology, approach, and data mining techniques to output valid and complaint patterns (e.g., recommended event sequences) using AI/ML algorithms.

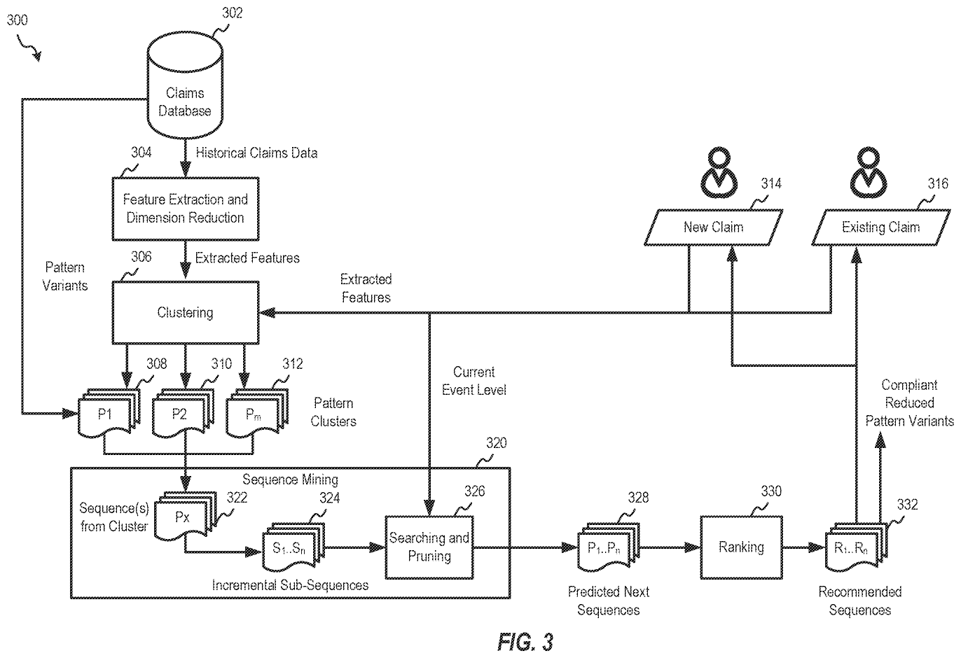

Referring to FIG. 3, an example of a process flow for automated event sequence recommendation for electronic processing of insurance claims according to one or more aspects is shown as a flow 300. In some implementations, the flow 300 may include or correspond to a process flow performed by the system 100 of FIG. 1 (or portions thereof) in the context of performance by the client device 150 of an electronic insurance claim handling process.

The flow 300 includes feature extraction and dimension reduction, at 304. For example, historical claims data are obtained from a claims database 302, and features are extracted from the historical claims data. In some implementations, an affinity analysis may be performed on the extracted features to identify principal features, which are features that have a variance that satisfies a threshold in the affinity analysis. The feature reduction may be performed by discarding the least important features to reduce the dimensions of the extracted features. Examples of feature variance from an affinity analysis are described further herein with reference to FIG. 6. In some implementations, the data for training the clustering ML models may be ingested from a claim process system application database as a particular type of file, such as a .csv file. An extract, transform, load (ETL) system may pull columns from different tables, such as claims, claim history, claim event, and the like, and the output may be the flat file as ingested, such as a .csv file. The columns that are pulled may include or correspond to features for claim_number, claim_event, claim_event_description, claim_event_time, claim_status, claim_sensitivity, claim_LOB, claim_filetype, claim_complexity, claim_regulatory_state, claim_regulatory_country, claim_handling_company, claim_suit_filed, claim_allow_auto, claim_LOB_category, or the like. Examples of principal features may include claim_status, claim_LOB, regulatory_state, and claim_LOB_category, as non-limiting examples. This process of data transformation and selection of principal features may include converting categorical columns of data into ordinal encoding to assist the clustering ML models and reducing the amount of features to improve speed and reduce resources of the recommendation process, in some implementations.

The flow 300 includes clustering the extracted features, at 306. For example, one or more ML models are trained to use unsupervised learning to assign the extracted features to multiple clusters according to a clustering algorithm. The clustering may result in clusters of features that represent event sequences (e.g., pattern clusters), such as a first cluster 308, a second cluster 310, and a third cluster 312. Although three clusters are shown, in other examples, fewer than three or more than three clusters may be formed as a result of the clustering 306. Each member of the clusters 308-312 correspond to a pattern (e.g., an event sequence) performed during prior instances of the electronic insurance claim handling process indicated by the historical claims data from the claims database 302.

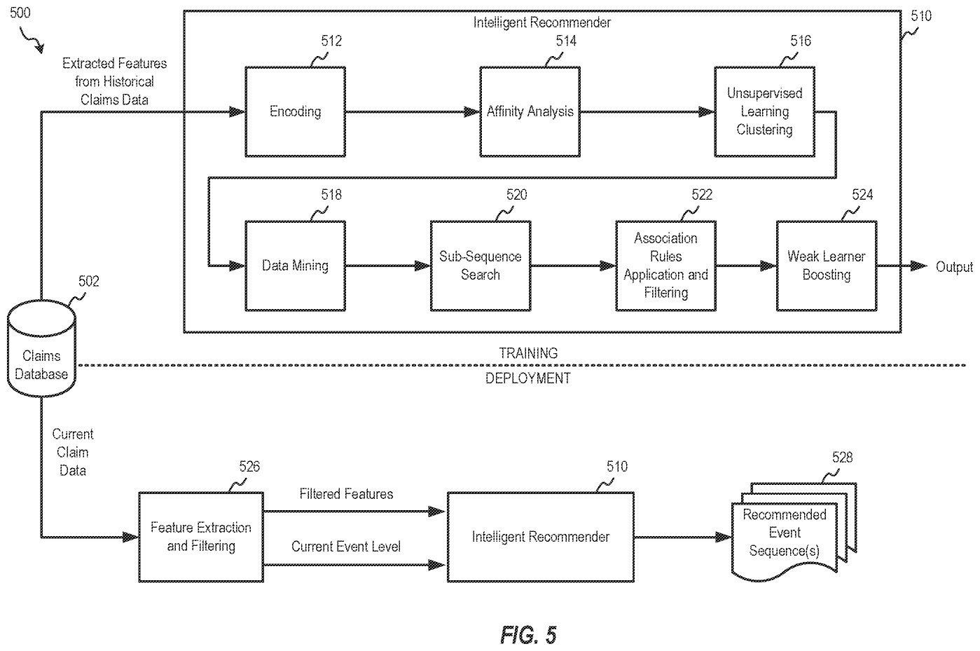

The flow 300 includes receiving a new claim 314 or an existing claim 316 (e.g., a current claim). Features are extracted from the existing claim 316 (or the new claim 314) and, after reduction based on the principal features, the extracted features are provided for clustering, at 306, to be assigned to one of the clusters 308-312. Clustering input feature sets identify potential segments of event sequences based on the principal extracted features using unsupervised ML techniques. This segmentation approach filters out relevant patterns (e.g., event sequences) from vast quantities of pattern variants (e.g., different event sequences). The assigned cluster is identified as input to sequence mining, at 320. The sequence mining may include extracting candidate event sequences from the assigned cluster, at 322. In some implementations, the sequence mining is performed based on a unique algorithm for pattern mining, incremental sub-latticing, searching, and pruning, as further described herein with reference to FIG. 5. The sequence mining also includes generating incremental candidate sub-sequences, at 324. Generating the incremental candidate sub-sequences predicts horizontal event nodes learnt from one or more ML models. The sequence mining also includes searching and pruning, at 326.

Predicted next event sequences 328 (e.g., at least one predicted next event sequence) determined by the sequence mining are provided as input for ranking, at 330. For example, the predicted next event sequences 328 may be ranked in order of corresponding association rule scores. A particular number of highest ranked event sequences may be output as recommended event sequences 332 (e.g., at least one recommended event sequence), and the recommended event sequences 332 may be provided to a client device to be used to complete handling of the existing claim 316 (or the new claim 314). Sorting the predicted event sequences in order of high support and confidence (e.g., scores) may result in recommending the top ranked event sequences based on the horizontal event point (e.g., the current event level) and claim attributes. Additionally or alternatively, the recommended event sequences 332 may be stored as a set of compliant, reduced pattern variants, for use in further training one or more ML models to perform any of the operations described with reference to FIG. 3 or other operations associated with the recommendation process, such as further sequence reduction, channelization, or the like.

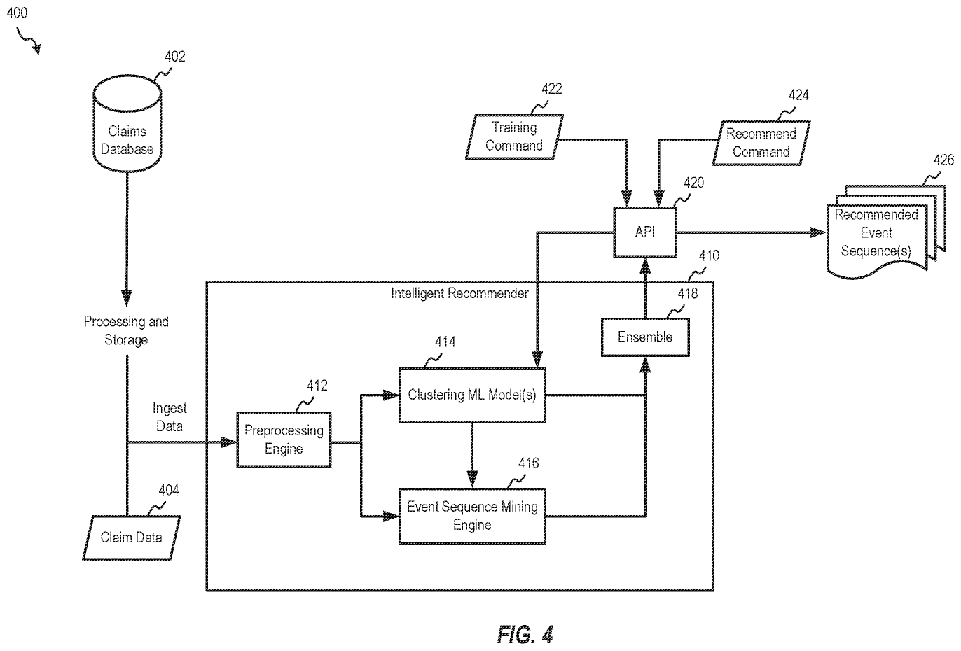

Referring to FIG. 4, an example of a system for automated event sequence recommendation for electronic processing of insurance claims according to one or more aspects is shown as a system 400. In some implementations, the system 400 may include or correspond to the system 100 of FIG. 1 (or portions thereof) in the context of performance by the client device 150 of an electronic insurance claim handling process. Additionally or alternatively, the system 400 may be configured to perform one or more operations described above with reference to the flow 300 of FIG. 3. The system may include a claims database 402, an intelligent recommender 410, and an application programming interface (API) 420. The intelligent recommender 410 may include a preprocessing engine 412, one or more clustering ML models (referred to herein as “clustering ML models 414”), an event sequence mining engine 416, and an ensemble 418.

During operation, historical claims data is retrieved from the claims database 402 and undergoes processing and storage. For example, an ETL system may transform claim data into a more useful format for the intelligent recommender 410, as described above with reference to FIG. 3. Additionally, or alternatively, the historical claims data is ingested as input data by the intelligent recommender 410. The preprocessing engine 412 performs one or more preprocessing operations on the historical claims data to clean up and format the historical claims data, as well as to extract features from the historical claims data. In some implementations, the extracted features may be reduced to a set of principal features determined based on performance of an affinity analysis on the extracted features, as described above with reference to FIGS. 1 and 3. The preprocessing engine 412 provides the extracted features as training data to the clustering ML models 414. Based on receipt of a training command 422 at the API 420, the API 420 may initiate training of the clustering ML models 414 features extracted from the historical claim data. The clustering ML models 414 are trained to cluster feature sets representing event sequences into multiple clusters using unsupervised learning. For example, the clustering ML models 414 are trained to perform clustering based on a clustering algorithm, such as K-modes clustering, as a non-limiting example. After training, the clustering ML models 414 are deployed for use by the intelligent recommender 410 to provide action recommendation services.

Based on receive of a recommend command 424 at the API 420, the API 420 initiates a process to provide recommended event sequences by the intelligent recommender 410. For example, the intelligent recommender may receive claim data 404 that represents events performed during a current iteration of the electronic claim handling process to handle a current claim. The claim data 404 could be ingested by the intelligent recommender 410 and preprocessed by the preprocessing engine 412 similar to the historical claim data from the claims database 402. The preprocessing engine 412 provides extracted features from the claim data 404 (e.g., after preprocessing and feature reduction to the principal features) as input data to the clustering ML models 414. The clustering ML models 414 assign the input feature set to one of the multiple clusters, and the assigned cluster is provided as input to the event sequence mining engine 416 to extract event sequences that correspond to members of the assigned cluster as candidate event sequences (e.g., candidate pattern sequences or candidate lattices). The event sequence mining engine 416 filters the candidate event sequences based on comparisons of one or more corresponding association rule sets to one or more thresholds. For example, the event sequence mining engine 416 applies associative rules to the candidate event sequences to determine corresponding scores for each, such as support, confidence, and lift scores, and the candidate event sequences that have scores that fail to satisfy one or more thresholds may be discarded. After the candidate event sequence reduction, the event sequence mining engine 416 generates multiple incremental candidate event sub-sequences (e.g., incremental candidate pattern sub-sequences or incremental candidate sub-lattices). The event sequence mining engine 416 prunes the candidate event sub-sequences based on a current event level derived from the claim data 404 to discard candidate event sub-sequences that do not include the current event level or the appropriate antecedents. Additionally, or alternatively, the event sequence mining engine 416 filters the candidate event sub-sequences to discard sub-sequences with corresponding association rule scores that fail to satisfy the one or more thresholds.

The ensemble 418 ensembles the outputs of the clustering ML models 414 and the event sequence mining engine 416 to generate a list of candidate recommended event sequences (e.g., candidate recommended pattern variants/sequences). The ensemble 418 ranks the candidate event sequences based on the corresponding association scores and may output a particular number of highest ranked candidate recommended event sequences as at least one recommended event sequence (referred to herein as “recommended event sequences 426”). The API 420 receives the recommended event sequences 426 and routes them to a client device or other destination to enable performance of one or more actions indicated by the recommended event sequences 426 to complete the electronic insurance claim handling process for the current claim. Thus, the system 400 is configured to predict next event sequences in the electronic insurance claim handling process by extracting and modelling different dimensions of attributes available in a claim using an appropriate clustering algorithm and data mining techniques. These recommended (e.g., highest ranked) event sequences are provided to client devices for use by claim process agents to handle the respective insurance claims. In some implementations, feature engineering, feature extraction, unsupervised learning, and data mining may be integrated sequentially in the system 400 as application programming interfaces (APIs) using a boosting ensemble technique. Additionally, or alternatively, data mining and cluster ML models, either separately or in combination, could be deployed as containerized APIs and exposed as a prediction API to downstream applications. In some such implementations, the containerized APIs are deployed as executable file packages in accordance with a Docker file format or another type of container file format. The prediction API is consumed by downstream applications, ingests attributes (e.g., features) and current horizontal event (e.g., current event level) of a claim as an input, and outputs the recommended event sequences in one or more particular formats.

Referring to FIG. 5, an example of a process flow for training and deployment of the intelligent recommender 410 of FIG. 4 (e.g., an intelligent recommendation engine) according to one or more aspects is shown as a flow 500. In the example shown in FIG. 5, an intelligent recommender 510 includes or corresponds to the intelligent recommender 410 of FIG. 4. In the example shown in FIG. 5, the flow 500 is divided into two phases: training and deployment.

The training phase of the flow 500 begins with the intelligent recommender 510 receiving extracted features from historical claims data from a claims database 502 as training data. Although not shown, the historical claims data may be processed, stored, or otherwise manipulated to generate the training data ingested by the intelligent recommender 510. The extracted features are provided for encoding, at 512. The encoding encodes the extracted features into a common feature type, such as via ordinal encoding or nominal encoding. For example, feature engineering is performed to convert categorical data into numerical data using ordinal encoding. After the encoding, the encoded features are provided for an affinity analysis, at 514. For example, the intelligent recommender 510 performs an affinity analysis on the features to identify the features with the most variance with respect to the event sequences, and these features (e.g., a particular number of features having the highest variance or features with variance that satisfies a threshold) are identified as principal features. Discarding features other than the principal features reduces the dimensionality of the data used for training (and eventually processing). The principal features are provided to ML models for unsupervised learning clustering, at 516. For example, the ML models are configured to assign the received feature sets to multiple clusters based on execution of a clustering algorithm. In some implementations, the ML models are trained to perform K-modes clustering with a Huang initial seeding artefact (e.g., a dissimilarity coefficient-based seeding artefact) to create clusters based on frequency of vertical patterns and horizontal event sequences. Using Huang dissimilarity measure (e.g., dissimilarity coefficients) seeding segments categorical data using a frequency-based method that updates the modes in the segmentation process, thereby reducing or minimizing a cost function. In some such implementations, the initial number of clusters is determined based on an Elbow optimization method. In some other implementations, the ML models are trained to perform other types of clustering, such as K-means or other clustering algorithms, and/or the initial seeding artefact may be a different type, such as a random initial seeding.

The event sequences corresponding to members of the clusters are provided for data mining, at 518. For example, the data mining includes identifying a unique set of event sequences that correspond to one or more of the clusters as candidate event sequences. The data mining further includes reducing the candidate event sequences by applying associative rules to the candidate event clusters to generate association rule scores and discarding candidate event sequences having association rule scores that fail to satisfy one or more thresholds. In some implementations, this data mining includes extracting a distinct list of vertical patterns associated with members of a cluster (e.g., a selected cluster during deployment) and applying an algorithm to search and extract horizontal event sequences that have higher scores (e.g., more support and confidence) than one or more thresholds. The reduced set of candidate event sequences is provided for sub-sequence search, at 520. For example, the intelligent recommender 510 generates multiple incremental candidate event sub-sequences based on the candidate event sequences. In some implementations, the candidate event sub-sequences are pruned based on a particular event level (e.g., a current event level) and antecedents of the current event level, as described above with reference to FIGS. 1 and 3. This part of the data mining process is also referred to as interlacing search, pruning, pattern mining, and incremental latticing to generate the candidate event sub-sequences. Generating and pruning the candidate event sub-sequences in this manner creates different combinations of event sub-sequences (e.g., sub-lattices) from each candidate event sequence (e.g., main lattice) to create a search space. From the candidate event sub-sequences, antecedents and consequents for each horizontal event sequence are derived by considering the current horizontal node (e.g., a current event level) as the antecedents. As an illustrative example, Table 1 below includes an example of candidate event sequences, where each event is denoted by a number, Table 2 below includes antecedents and consequents derived from the candidate event sequences of Table 1, and Table 3 below includes antecedents and consequents of remaining candidate event sequences after pruning based on the current event level.

TABLE 1
Illustrative Candidate Event Sequences
Event Sequence (e.g., Pattern)

10, 85, 73, 197, 241, 257
10, 85, 73, 197, 241, 257, 85, 133, 84
10, 85, 73, 197, 2, 257, 133, 84, 127, 316, 71
10, 85, 73, 2
10, 85, 73, 197, 241, 257
10, 85, 73, 197, 2, 257

TABLE 2
Illustrative Antecedents and Consequents

| Antecedents | Consequents |
|---|---|
| 10, 85 | 73 |
| | 73, 197 |
| | 73, 197, 241 |
| | 73, 197, 241, 257 |
| 10, 85 | 73 |
| | 73, 197 |
| | 73, 197, 241 |
| | 73, 197, 241, 257 |
| | 73, 197, 241, 257, 133 |
| | 73, 197, 241, 257, 133, 84 |
| 10, 85 | 73 |
| | 73, 2 |
| 10, 85 | 73 |
| | 73, 197 |
| | 73, 197, 2 |
| | 73, 197, 2, 257 |

TABLE 3
Illustrative Antecedents and Consequents
after Search (e.g., Filtering)

| Antecedents | Current Event | Consequents |
|---|---|---|
| 10, 85 | 197 | 241 |
| | | 241, 257 |
| | | 133, 84 |

As another example, the following unique candidate event sequences (e.g., lattices) are identified, and the following unique pruned incremental candidate event sub-sequences (e.g., sub-lattices) are generated and pruned based on a current horizontal event being [10].

Unique Lattices:
[10, 85, 73, 73, 266, 306, 197, 133, 85, 2, 84]
[10, 85, 73, 197, 85, 2, 257, 133, 84, 133, 84, 127, 316, 73, 133, 84, 133, 84, 73, 145]
[133, 84, 133, 84, 127, 316, 127, 316]
[10, 85, 105, 73, 85, 2, 73, 133, 84, 127, 95, 95]
[10, 85, 85, 2]
[10, 85, 73, 197, 85, 2, 257, 133, 84, 127, 316, 133, 84, 73, 133, 84, 73, 289, 290]
[10, 85, 73, 197, 85, 2, 257]
[133, 84, 133, 84, 133, 84, 127, 127, 127]
[73, 133, 84, 73, 133, 84, 133, 84, 133, 84, 133, 84, 73, 133, 84]
[95, 95]
[95, 95, 95, 95, 95, 95, 95, 95, 95, 95]
[10, 85, 73, 197, 85, 2, 257, 133, 84, 127, 316]
[133, 84, 314]
[133, 84, 127, 316]
[266, 266]
[10, 85, 105, 73, 85, 2, 133, 84, 127, 316, 133, 84, 127, 316]
[133, 84]
[133, 84, 133, 84]
[10, 85, 105, 73, 85, 2, 133, 84, 127, 316]
[10, 85, 73, 306, 197, 85, 2, 257, 133, 84, 127, 316]
[10, 85, 105, 73, 85, 2, 145, 133, 84, 127, 316]

Unique Pruned Incremental Sub-Lattices:
[85, 73, 73, 266, 306, 197, 133, 85, 2, 84]
[85, 73, 197, 85, 2, 257, 133, 84, 133, 84, 127, 316, 73, 133, 84, 133, 84, 73, 145]
[85, 105, 73, 85, 2, 73, 133, 84, 127, 95, 95]
[85, 85, 2]
[85, 73, 197, 85, 2, 257, 133, 84, 127, 316, 133, 84, 73, 133, 84, 73, 289, 290]
[85, 73, 197, 85, 2, 257]
[85, 73, 197, 85, 2, 257, 133, 84, 127, 316]
[85, 105, 73, 85, 2, 133, 84, 127, 316, 133, 84, 127, 316]
[85, 105, 73, 85, 2, 133, 84, 127, 316]
[85, 73, 306, 197, 85, 2, 257, 133, 84, 127, 316]
[85, 105, 73, 85, 2, 145, 133, 84, 127, 316]

The candidate event sub-sequences are provided for associative rules application and filtering, at 522. For example, the intelligent recommender 510 applies associative rules to the candidate event sub-sequences to generate association rule scores for the candidate event sub-sequences, and the candidate event sub-sequences are filtered to remove sub-sequences having scores that fail to satisfy one or more thresholds. In some implementations, the associative rule scores may include support scores, lift scores, and confidence scores. In some such implementations, the support, lift, and confidence thresholds are calculated based on percentile of medium range of 50%. In other implementations, the associative rule scores and/or the thresholds may be different. The reduced set of candidate event sub-sequences are provided for weak learner boosting, at 524. For example, the weak learner boosting include use of ML models or techniques to further strengthen the previously-described operations, and the remaining candidate event sub-sequences are ranked and a particular number of highest ranking candidate event sub-sequences are output as recommended event sequences. The boosting acts on the weak learners (e.g., the clustering and the data mining) sequentially in an adaptive way and combine them based on a deterministic strategy, such as a segmentation-cum-pruning mechanism. Such ‘boosting ensemble’ technique bridges between unsupervised learning and event sequence data mining by successfully pipelining the flow of prediction data in a filtered manner and narrowing down towards an accurate result. In some implementations, one or more of elements 516-524 involve training of ML models for deployment to support real time or near-real time action recommendation services, and the above-provided descriptions correspond to operations performed during training of the ML models. In some other implementations, one or more of elements 516-524 do not leverage ML, and the above-provided descriptions are operations performed during deployment of the intelligent recommender 510.

The deployment phase of the flow 500 begins with receiving current claim data from the claims database 502 or from a client device that subscribes to the action recommendation services provided by the intelligent recommender 510. Although described as current claim data, the current claim may also be a new claim. The current claim data is provided for feature extraction and filtering, at 526. For example, the current claim data is preprocessed and features are extracted from the processed current claim data. The features may be reduced by discarding features that do not correspond to the principal features (or only features that correspond to the principal features may be extracted). The filtered extracted features and a current event level included in or derived from the current claim data may be provided to the intelligent recommender 510 for performance of one or more operations described above with respect to the flow 500 during the training phase. For example, the filtered features may be assigned to a cluster, and data mining, sub-sequence searching, associative rules application and filtering, and weak learner boosting may be performed to generate a ranked list of candidate event sub-sequences. The intelligent recommender 510 outputs one or more of the highest ranking candidate event sub-sequences as recommended event sequences 528, which may be provided to a client device to enable the client device and/or a user of the client device to perform one or more actions indicated by the recommended event sequences to handle the current claim.

In some implementations, at least some of the data mining is performed based one or more unique algorithms. In a particular example, the data mining is performed based on a co-occurrence pattern mapping—incremental sub sequencing—sequence pattern mining (CM-IS-SPADE) search and pruning algorithm. The algorithm discovers all frequent sequential patterns, decomposes the original search space (e.g., lattice) into smaller pieces (e.g., sub-lattices) that are incrementally ordered, and performs depth-first-search (DFS) on these pieces, including pruning, as compared to other search or pruning algorithms with associated drawbacks of not producing equivalence classes or incremental sub-sequences/lattices, performing breadth-first-search (BF S) and DFS, which decreases performance, or failing to sequence mine or search. Thus, data mining according to some aspects of the present disclosure interlaces the following techniques: discovering all frequent sequential patterns above one or more thresholds; performing horizontal-to-vertical transformation of event sequences on-the-fly for better search (e.g., converting all BF S into DFS and then reducing the number of event sequences by considering only distinct event sequences, which eventually reduces the number of scans in the search); producing sub-lattices from lattices in an incremental list ordering; and during generation of sub-lattices, pruning the irrelevant combinations (e.g., non-co-occurrence sub-lattices), which narrows the search down to a specific optimal list of event sub-sequences and thereby increases the accuracy of recommended event sequences.

FIG. 6 illustrates examples of feature variance resulting from affinity analysis according to one or more aspects. In the particular example shown in FIG. 6, a first variance plot 600 and a second variance plot 602 are shown for a first particular parameter (“Regulatory State Parameter”) and a second particular parameter (“Regulatory Country Parameter”), respectively. The affinity analysis may be performed to determine which features have high variance with respect to various patterns (e.g., event sequences) indicated by historical event data (e.g., historical claim data for implementations in which a structured process is an electronic insurance claims handling process). In the example shown in FIG. 6, the first variance plot 600 shows that the first particular parameter has high variance with respect to the patterns and the second variance plot 602 shows that the second particular parameter has low variance with respect to the patters. For example, different patterns tracked in the first variance plot 600 are well distributed between multiple different values for the first particular parameter, such as AL, NJ, NY, CA, and TX, among others, while different patterns tracked in the second variance plot 602 are mostly distributed to a single value of the second particular parameter. If the variance for the second particular parameter fails to satisfy a threshold and the variance for the first particular parameter satisfies the threshold, the first particular parameter may be identified as a principal feature and the second particular parameter may be identified as not being a principal feature. In such an example, the second particular parameter may be discarded during feature reduction to focus the recommendation processes described herein on features that have a larger effect on selection of event sequences (e.g., patterns).

Referring to FIG. 7, an example of a system for supporting a channelized reflexive virtual agent that supports electronic processing of insurance claims according to one or more aspects is shown as a system 700. In some implementations, the system 700 may include or correspond to the system 100 of FIG. 1 (or portions thereof) in the context of performance by the client device 150 of an electronic insurance claim handling process. The system 700 includes an intelligent recommender 706, one or more channelizing ML models (referred to herein as “channelizing ML models 710”), and a channelized reflexive virtual agent 714. In some implementations, the intelligent recommender 706 includes or correspond to the intelligent recommender 410 of FIG. 4 or the intelligent recommender 510 of FIG. 5. The channelizing ML models 710 are trained to channelize input event sequences into channelized event sequences that each correspond to one of multiple layers of the structured process. The channelized reflexive virtual agent 714 includes multiple types of layer-specific AI and ML services 716-722 that correspond to each of the layers of the structured process, an ensemble 724 that ensembles the outputs of the AI and ML services 716-722, and channel(s) 726 that receive event sequences for respective channels from the channelizing ML models 710 for processing by one or more of the AI and ML services 716-722. In the example shown in FIG. 7 in which the structured process in an electronic insurance claim handling process, the AI and ML services include first notice of loss (FNOL) AI/ML services 716, coverage/eligibility AI/ML services 718, adjudication AI/ML services 720, and settlement and recovery AI/ML services 722. In other examples, the channelized reflexive virtual agent 714 includes fewer than four or more than four AI/ML services and/or different AI/ML services than shown in FIG. 7.

During operations of the system 700, the intelligent recommender 706 may receive claim data that indicates a new claim 702 or an existing claim 704 (e.g., a current claim). The intelligent recommender 706 performs one or more of the operations described above with reference to FIGS. 1-6 to output recommended event sequences 708 (e.g., a particular number of highest ranked candidate event sequences). The recommended event sequences 708 are provided as input data to the channelizing ML models 710 to generate at least one channelized event sequence (referred to herein as “channelized event sequences 712”). Each of the channelized event sequences 712 corresponds to one of the layers of the electronic insurance claim handling process, such as a FNOL layer, a coverage/eligibility layer, an adjudication layer, and a settlement and recovery layer, and the channelized event sequences 712 are provided to the channelized reflexive virtual agent 714 for handling of the new claim 702 or the existing claim 704 indicated by the claim data received by the intelligent recommender 706. The channelized event sequences 712 are routed to the appropriate channel of the channels 726 to route each event sequence to one of the AI/ML services 716-722 that corresponds to the channel. As non-limiting examples, a first channelized event sequence that corresponds to the FNOL layer is routed, via a first channel of the channels 726, to the FNOL AI/ML services 716 (e.g., a subset of AI/ML services or models that correspond to the FNOL layer), and a second channelized event sequence that corresponds to the adjudication layer is routed, via a third channel of the channels 726, to the adjudication AI/ML services 720 (e.g., a subset of AI/ML services or models that correspond to the adjudication layer). After routing and processing of all of the channelized event sequences 712 by the AI/ML services 716-722 (e.g., the AI/ML services 716-722 perform one or more indicated actions to handle aspects, or an entirety, of the new claim 702 or the existing claim 704), any outputs of the AI/ML services 716-722 are ensembled by the ensemble 724 and provided to client device(s) for display to user(s) and/or performance of any remaining actions needed to complete handling of the new claim 702 or the existing claim 704. In some implementations, the channelized reflexive virtual agent 714 receives claim details of the new claim 702 or the existing claim 704 in addition to the channelized event sequences 712 to enable performance of actions to handle the new claim 702 or the existing claim 704.

In the context of an electronic insurance claim handling process, channelizing pattern variants increases the accuracy in choosing the right horizontal event sequences and predominantly help to implement end-to-end CRV, which may pave the way to achieve straight-through-processing (STP) and significantly reduce claim response time and increase customer satisfaction. To illustrate, after generating the recommended event sequences 708, the channelizing ML models 710 (e.g., AI/ML models) may channelize the event sequences (e.g., patterns) to reduce the number of variant event sequences in the channelized event sequences 712. CRV may be created utilizing the channelized event sequences 712 ensembled with the AI/ML services 716-722 (e.g., at each layer of the electronic insurance claim handling process). In this manner, the channelized reflexive virtual agent 714 responds to insurance claims quickly and completely, such as all the way through the settlement and recovery process, thereby covering all layers in the electronic insurance claim handling process.

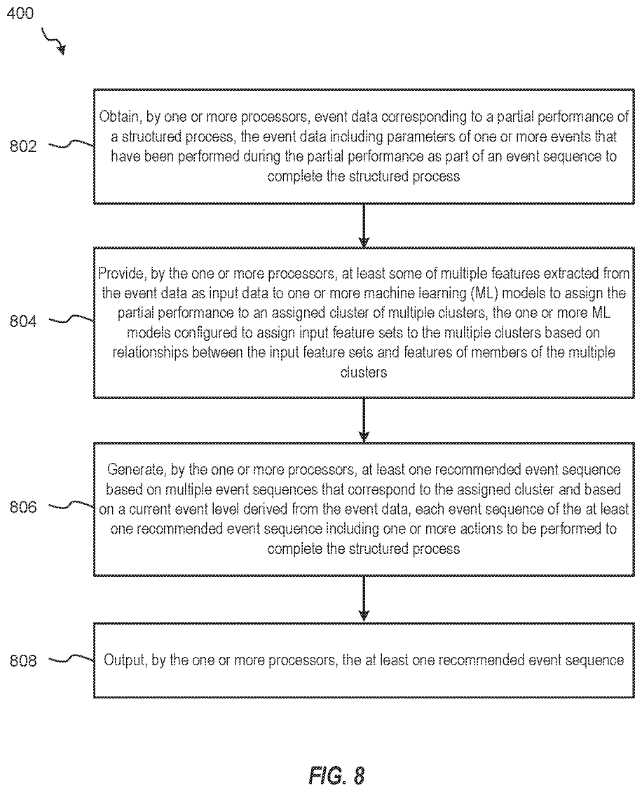

Referring to FIG. 8, a flow diagram of an example of a method for automated action recommendation for structured processes according to one or more aspects is shown as a method 800. In some implementations, the operations of the method 800 are stored as instructions that, when executed by one or more processors (e.g., the one or more processors of a computing device or a server), cause the one or more processors to perform the operations of the method 800. In some implementations, the method 800 are performed by a computing device, such as the server 102 of FIG. 1 (e.g., a computing device configured to support automated action recommendation for structured processes), the intelligent recommender 410 (e.g., a recommendation engine) of FIG. 4, the intelligent recommender 510 of FIG. 5, the intelligent recommender 706, the channelizing ML models 710, and the channelized reflexive virtual agent 714 of FIG. 7, or a combination thereof.

The method 800 includes obtaining event data corresponding to a partial performance of a structured process, at 802. For example, the event data may include or correspond to the event data 160 of FIG. 1. The event data includes parameters of one or more events that have been performed during the partial performance as part of an event sequence to complete the structured process. For example, the parameters may include or correspond to the parameters 162 of FIG. 1. The method 800 includes providing at least some of multiple features extracted from the event data as input data to one or more ML models to assign the partial performance to an assigned cluster of multiple clusters, at 804. For example, the multiple features may include or correspond to the extracted features 110 of FIG. 1, and the one or more ML models may include or correspond to the first ML models 126 of FIG. 1. The one or more ML models are configured to assign input feature sets to the multiple clusters based on relationships between the input feature sets and features of members of the multiple clusters. For example, the multiple clusters and the members thereof may be represented by the cluster data 112 of FIG. 1

The method 800 includes generating at least one recommended event sequence based on multiple event sequences that correspond to the assigned cluster and based on a current event level derived from the event data, at 806. For example, the at least one recommended event sequence may include or correspond to the event sequences 170 of FIG. 1, the multiple event sequences may include or correspond to the candidate event sequences 130 of FIG. 1, and the current event level may include or correspond to the event level 164 of FIG. 1. Each event sequence of the at least one recommended event sequence includes one or more actions to be performed to complete the structured process. The method 800 includes outputting the at least one recommended event sequence, at 808. For example, the at least one recommended event sequence may include or correspond to the recommended event sequences 170 of FIG. 1.

In some implementations, outputting the at least one recommended event sequence includes initiating display of a GUI that includes the at least one recommended event sequence. For example, the GUI may include or correspond to the GUI 172 of FIG. 1. Additionally, or alternatively, outputting the at least one recommended event sequence includes outputting one or more instructions to initiate performance of one or more actions indicated by the at least one recommended event sequence. For example, the one or more instructions may include or correspond to the instructions 174 of FIG. 1.

In some implementations, generating the at least one recommended event sequence includes generating multiple candidate event sequences that represent the multiple event sequences that correspond to the assigned cluster, generating multiple incremental candidate event sub-sequences based on the multiple candidate event sequences, and pruning the multiple incremental candidate event sub-sequences based on the current event level. After the pruning, the multiple incremental candidate event sub-sequences include the at least one recommended event sequence. For example, the multiple candidate event sequences may include or correspond to the candidate event sequences 130 of FIG. 1, the multiple incremental candidate event sub-sequences may include or correspond to the candidate event sub-sequences 132 of FIG. 1, and the current event level may include or correspond to the event level 164 of FIG. 1. In some such implementations, generating the at least one recommended event sequence also includes determining one or more scores corresponding to the multiple incremental candidate event sub-sequences based on associative rules and filtering the multiple incremental candidate event sub-sequences to remove candidate event sub-sequences for which the corresponding one or more scores fail to satisfy one or more thresholds. For example, the sequence mining engine 128 of FIG. 1 may determine association rule scores corresponding to the candidate event sub-sequences 132 and filter the candidate event sub-sequences 132 to remove candidate event sub-sequences having scores that fail to satisfy one or more thresholds. In some such implementations, generating the at least one recommended event sequence further includes ranking remaining candidate event sub-sequences based on the corresponding one or more scores and selecting a threshold number of highest ranking candidate event sub-sequences of the remaining candidate event sub-sequences as the at least one recommended event sequence. For example, the sequence mining engine 128 of FIG. 1 ranks the remaining sub-sequences of the candidate event sub-sequences 132 based on corresponding association rule scores and output a particular number of highest ranked candidate sub-sequences as the recommended event sequences 170 of FIG. 1. Additionally, or alternatively, the one or more scores include a support score, a confidence score, and a lift score.

In some implementations, the method 800 also includes extracting features from historical event data corresponding to one or more past performances of the structured process to generate training data. The historical event data indicates parameters of events that have been performed during the one or more past performances of the structured process. For example, training data may include or correspond to the training data 114 of FIG. 1. The method 800 further includes providing the training data to the one or more ML models to train the one or more ML models to perform unsupervised learning-based clustering to assign event sequences to the multiple clusters based on extracted features corresponding to the event sequences. For example, the first ML models 126 of FIG. 1 are trained to assign feature sets to multiple clusters, and the multiple clusters (e.g., the members thereof and corresponding event sequences) are indicated by the cluster data 112. In some such implementations, the method 800 also includes determining an initial seeding of the multiple clusters based on dissimilarity coefficients between candidate members of the multiple clusters. For example, the dissimilarity coefficients may include or correspond to the dissimilarity coefficients 116 of FIG. 1. Additionally, or alternatively, the method 800 further includes performing affinity analysis on the features extracted from the historical event data to identify a subset of the features for which variance satisfies a threshold as principal features. For example, the principal features may include or correspond to the principal features 118 of FIG. 1. In some such implementations, the method 800 also includes extracting the multiple features from the event data and discarding one or more of the multiple features that do not correspond to the principal features to generate the at least some of the multiple features. For example, the preprocessing engine 122 of FIG. 1 may discard one or more of the extracted features 110 that do not correspond to the principal features 118.

In some implementations, the method 800 also includes preprocessing the event data or the training data prior to extracting the multiple features. The preprocessing includes removing empty data sets, validating the parameters of the one or more events included in the event data, converting at least a portion of the event data to a common format, or a combination thereof. For example, the preprocessing engine 122 of FIG. 1 may be configured to preprocess the extracted features 110 or the training data 114. Additionally, or alternatively, the structured process may be an insurance claim process, and the at least one recommended event sequence represents at least one sequence of actions to process an insurance claim in compliance with the insurance claim process. An example of such a structured process is further described herein with reference to FIG. 2.

In some implementations, the method 800 also includes providing the at least one recommended event sequence as input data to one or more second ML models to generate at least one channelized event sequence. The one or more second ML models are configured to channelize input event sequences into channelized event sequences that each correspond to one of multiple layers of the structured process. For example, the one or more second ML models may include or correspond to the second ML models 136 of FIG. 1, and the at least one channelized event sequence may include or correspond to the channelized event sequences 119 of FIG. 1. In some such implementations, the method 800 also includes routing the at least one channelized event sequence to multiple ML models of a virtual agent configured to automatically perform the structured process. Each ML model of the multiple ML models corresponds to a layer of the multiple layers of the structured process, and the multiple ML models are ensembled to generate an output of the virtual agent. For example, the virtual agent may include or correspond to the channelized reflexive virtual agent 714 of FIG. 7, and the multiple ML models may include or correspond to the FNOL AI/ML services 716, the coverage/eligibility AI/ML, services 718, the adjudication AI/ML services 720, and the settlement and recovery AI/ML services 722 of FIG. 7. In some such implementations, the method 800 further includes determining a first layer of the multiple layers that corresponds to a first channelized event sequence of the at least one channelized event sequence, and routing the first channelized event sequence to a subset of the multiple ML models that correspond to the first layer. For example, the channelized event sequences 712 are routed via the channels 726 of the channelized reflexive virtual agent 714 to the appropriate AI/ML service of the AI/ML services 716-722, and the outputs are ensembled by the ensemble 724.

As described above, the method 800 supports automated action recommendation for structured processes. The recommendation services provided by the method 800 are provided using fewer processing resources and in a shorter time period than other types of recommendation services. For example, the sequence mining described with reference to the method 800 may reduce the number of candidate event sequences and candidate event sub-sequences through application of one or more associative rules, resulting in a smaller amount of sequences to search through to determine recommended event sequences. Reducing this amount of sequences (e.g., the search space) reduces the amount of time to generate recommendations and the amount of processing and memory resources to perform the method 800.

Those of skill in the art would understand that information and signals may be represented using any of a variety of different technologies and techniques. For example, data, instructions, commands, information, signals, bits, symbols, and chips that are referenced throughout the above description may be represented by voltages, currents, electromagnetic waves, magnetic fields or particles, optical fields or particles, or any combination thereof.

It is noted that other types of devices and functionality may be provided according to aspects of the present disclosure and discussion of specific devices and functionality herein have been provided for purposes of illustration, rather than by way of limitation. It is noted that the operations of the method 800 of FIG. 8 may be performed in any order, or that operations of one method may be performed during performance of another method, such as the method 800 of FIG. 8 including one or more operations of the method 300 of FIG. 3 or one or more of the operations described with reference to FIG. 5. It is also noted that the method 800 of FIG. 8 may also include other functionality or operations consistent with the description of the operations of the system 100 of FIG. 1, the system 400 of FIG. 4, the system 700 of FIG. 7, or a combination thereof.

Components, the functional blocks, and the modules described herein with respect to FIGS. 1-8) include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules, and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor includes a microprocessor, or any conventional processor, controller, microcontroller, or state machine. In some implementations, a processor may also be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection is properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

What is claimed is:

1. A method for automated action recommendation for structured processes, the method comprising:
obtaining, by one or more processors, event data corresponding to a partial performance of a structured process,
wherein the event data includes parameters of one or more events that have been performed during the partial performance as part of an event sequence to complete the structured process;
providing, by the one or more processors, at least some of multiple features extracted from the event data as input data to one or more machine learning (ML) models to assign the partial performance to an assigned cluster of multiple clusters,
wherein the one or more ML models are configured to assign input feature sets to the multiple clusters based on relationships between the input feature sets and features of members of the multiple clusters;
generating, by the one or more processors, at least one recommended event sequence based on multiple event sequences that correspond to the assigned cluster and based on a current event level derived from the event data, each event sequence of the at least one recommended event sequence including one or more actions to be performed to complete the structured process; and
outputting, by the one or more processors, the at least one recommended event sequence.

2. The method of claim 1, wherein outputting the at least one recommended event sequence comprises initiating display of a graphical user interface (GUI) that includes the at least one recommended event sequence.

3. The method of claim 1, wherein outputting the at least one recommended event sequence comprises outputting one or more instructions to initiate performance of one or more actions indicated by the at least one recommended event sequence.

4. The method of claim 1, wherein generating the at least one recommended event sequence comprises:
generating, by the one or more processors, multiple candidate event sequences that represent the multiple event sequences that correspond to the assigned cluster;
generating, by the one or more processors, multiple incremental candidate event sub-sequences based on the multiple candidate event sequences; and
pruning, by the one or more processors, the multiple incremental candidate event sub-sequences based on the current event level,
wherein, after the pruning, the multiple incremental candidate event sub-sequences include the at least one recommended event sequence.

5. The method of claim 4, wherein generating the at least one recommended event sequence further comprises:
determining, by the one or more processors, one or more scores corresponding to the multiple incremental candidate event sub-sequences based on associative rules; and
filtering, by the one or more processors, the multiple incremental candidate event sub-sequences to remove candidate event sub-sequences for which the corresponding one or more scores fail to satisfy one or more thresholds.

6. The method of claim 5, wherein generating the at least one recommended event sequence further comprises:
ranking, by the one or more processors, remaining candidate event sub-sequences based on the corresponding one or more scores; and
selecting, by the one or more processors, a threshold number of highest ranking candidate event sub-sequences of the remaining candidate event sub-sequences as the at least one recommended event sequence.

7. The method of claim 5, wherein the one or more scores comprise a support score, a confidence score, and a lift score.

8. The method of claim 1, further comprising:
extracting, by the one or more processors, features from historical event data corresponding to one or more past performances of the structured process to generate training data,
wherein the historical event data indicates parameters of events that have been performed during the one or more past performances of the structured process; and
providing, by the one or more processors, the training data to the one or more ML models to train the one or more ML models to perform unsupervised learning-based clustering to assign event sequences to the multiple clusters based on extracted features corresponding to the event sequences.

9. The method of claim 8, further comprising:
determining, by the one or more processors, an initial seeding of the multiple clusters based on dissimilarity coefficients between candidate members of the multiple clusters.

10. The method of claim 8, further comprising:
performing, by the one or more processors, affinity analysis on the features extracted from the historical event data to identify a subset of the features for which variance satisfies a threshold as principal features.

11. The method of claim 10, further comprising:
extracting, by the one or more processors, the multiple features from the event data; and
discarding, by the one or more processors, one or more of the multiple features that do not correspond to the principal features to generate the at least some of the multiple features.

12. A system for automated action recommendation for structured processes, the system comprising:
a memory; and
one or more processors communicatively coupled to the memory, the one or more processors configured to:
obtain event data corresponding to a partial performance of a structured process,
wherein the event data includes parameters of one or more events that have been performed during the partial performance as part of an event sequence to complete the structured process;
provide at least some of multiple features extracted from the event data as input data to one or more machine learning (ML) models to assign the partial performance to an assigned cluster of multiple clusters,
wherein the one or more ML models are configured to assign input feature sets to the multiple clusters based on relationships between the input feature sets and features of members of the multiple clusters;
generate at least one recommended event sequence based on multiple event sequences that correspond to the assigned cluster and based on a current event level derived from the event data, each event sequence of the at least one recommended event sequence including one or more actions to be performed to complete the structured process; and
output the at least one recommended event sequence.

13. The system of claim 12, wherein the one or more processors are further configured to:
preprocess the event data or training data prior to extracting the multiple features,
wherein the one or more processors are configured to preprocess the event data by removing empty data sets, validating the parameters of the one or more events included in the event data, converting at least a portion of the event data to a common format, or a combination thereof.

14. The system of claim 12, wherein, to generate the at least one recommended event sequence, the one or more processors are configured to:
generate multiple incremental candidate event sub-sequences based on the multiple event sequences that correspond to the assigned cluster; and
filter the multiple incremental candidate event sub-sequences to remove candidate event sub-sequences that do not include the current event level and sub-sequences for which one or more association rule-based scores fail to satisfy one or more thresholds; and
select a threshold number of highest ranking remaining candidate event sub-sequences as the at least one recommended event sequence.

15. The system of claim 12, wherein the one or more processors are further configured to:
extract the multiple features from the event data; and
discard one or more of the multiple features that do not correspond to principal features prior to providing the at least some of the multiple features as input data to the one or more ML models,
wherein the principal features are identified based on an affinity analysis performed on features extracted from historical event data corresponding to one or more past performances of the structured process.

16. The system of claim 12, wherein the structured process is an insurance claim process, and wherein the at least one recommended event sequence represents at least one sequence of actions to process an insurance claim in compliance with the insurance claim process.

17. A non-transitory computer-readable storage medium storing instructions that, when executed by one or more processors, cause the one or more processors to perform operations for automated action recommendation for structured processes, the operations comprising:
obtaining event data corresponding to a partial performance of a structured process,
wherein the event data includes parameters of one or more events that have been performed during the partial performance as part of an event sequence to complete the structured process;
providing at least some of multiple features extracted from the event data as input data to one or more machine learning (ML) models to assign the partial performance to an assigned cluster of multiple clusters,
wherein the one or more ML models are configured to assign input feature sets to the multiple clusters based on relationships between the input feature sets and features of members of the multiple clusters;
generating at least one recommended event sequence based on multiple event sequences that correspond to the assigned cluster and based on a current event level derived from the event data, each event sequence of the at least one recommended event sequence including one or more actions to be performed to complete the structured process; and
outputting the at least one recommended event sequence.

18. The non-transitory computer-readable storage medium of claim 17, wherein the operations further comprise:
providing the at least one recommended event sequence as input data to one or more second ML models to generate at least one channelized event sequence,
wherein the one or more second ML models are configured to channelize input event sequences into channelized event sequences that each correspond to one of multiple layers of the structured process.

19. The non-transitory computer-readable storage medium of claim 18, wherein the operations further comprise:
routing the at least one channelized event sequence to multiple ML models of a virtual agent configured to automatically perform the structured process,
wherein each ML model of the multiple ML models corresponds to a layer of the multiple layers of the structured process, and
wherein the multiple ML models are ensembled to generate an output of the virtual agent.

20. The non-transitory computer-readable storage medium of claim 19, wherein the operations further comprise:
determining a first layer of the multiple layers that corresponds to a first channelized event sequence of the at least one channelized event sequence; and
routing the first channelized event sequence to a subset of the multiple ML models that correspond to the first layer.
